(19) United States
(12) Patent Application Publication
(10) Pub. No.: US 2023/0188951 A1
(43) Pub. Date: Jun. 15, 2023

(54) MULTICAST COMMUNICATION IMPROVEMENTS

(71) Applicant: MAXLINEAR, INC., Carlsbad, CA (US)

(72) Inventors: Saju Palayur, Carlsbad, CA (US); Oren Kedem, Modii'n-Maccabin-Reut (IL); Ido Shemer, Petah Tikva (IL); Avner Epstein, Petah Tikva (IL)

(21) Appl. No.: 18/056,172

(22) Filed: Nov. 16, 2022

Related U.S. Application Data
(60) Provisional application No. 63/265,352, filed on Dec. 13, 2021.
(60) Provisional application No. 63/365,595, filed on May 31, 2022.

(51) Int. Cl. H04W 4/08

(52) U.S. Cl. CPC H04W 4/08

(57) ABSTRACT

A method for communicating multicast traffic includes snooping data received from a plurality of devices. The plurality of devices is in wireless communication with the access point. The method includes determining a multicast group membership status of each of the devices based on a result from snooping.

### CROSS REFERENCE TO RELATED APPLICATIONS

This U.S. patent application claims priority to U.S. Provisional Pat. Application 63/265,352 filed on Dec. 13, 2021 and U.S. Provisional Pat. Application 63/365,595 filed on May 31, 2022. The disclosure of these prior applications are considered part of the disclosure of this application and are hereby incorporated by reference in their entirety.

### TECHNICAL FIELD

This disclosure relates to managing multicast traffic communication in various wireless environments.

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi. Some Wi-Fi communications include multicast support where data transmission may be addressed to multiple receiving devices simultaneously. Additionally, some Wi-Fi communications may be broadcast over different radio links that may include varying operational frequencies.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

One aspect of the disclosure provides a method for communicating multicast traffic. The method includes snooping, at an access point, data received from a plurality of devices. The plurality of devices is in wireless communication with the access point. The method also includes determining, by the access point, a multicast group membership status of each of the devices based on a result from snooping.

Implementations of the disclosure may include one or more of the following optional features. In some implementations, snooping the data from the plurality of devices includes identifying multicast group join requests and multicast group leave requests from the data. In some implementations, the multicast group join requests and multicast group leave requests are generated based on the internet group management protocol (IGMP). In some implementations, the multicast group join requests and multicast group leave requests are generated based on a multicast listener discovery protocol.

In some implementations, the method further includes transmitting, by the access point, the multicast traffic based on the multicast group membership status. In some implementations, transmitting the multicast traffic based on the multicast group membership status includes determining a target multicast group of the multicast traffic and transmitting the multicast traffic to devices of the plurality of devices that are associated with the target multicast group. In some implementations, the method further includes determining should this be “the” lowest modulation and coding scheme (MCS) for each multicast group which could be higher than the mandatory modulation and MCS, determining a target multicast group of the multicast traffic, and transmitting the multicast traffic to devices of the plurality of devices that are associated with the target multicast group using the lowest modulation and coding scheme (MCS) associated with the target multicast group. In some implementations, the method further includes determining a lowest modulation and coding scheme (MCS) for each multicast group, determining a target multicast group of the multicast traffic, and transmitting the multicast traffic to the plurality of devices using the lowest modulation and coding scheme (MCS) associated with the target multicast group. In some implementations, the method further includes generating a multicast group membership table based on the multicast group membership status. In some implementations, the access point includes at least one virtual access point.

Another aspect of the disclosure provides an access point for communication of multicast traffic. The access point includes data processing hardware and memory hardware in communication with the data processing hardware. The memory hardware stores instructions that when executed on the data processing hardware cause the data processing hardware to perform operations. The operations include snooping data received from a plurality of devices. The plurality of devices is in wireless communication with the access point. The operations also includes determining a multicast group membership status of each of the devices.

Implementations of the disclosure may include one or more of the following optional features. In some implementations, snooping the data from the plurality of devices includes identifying multicast group join requests and multicast group leave requests from the data. In some implementations, the multicast group join requests and multicast group leave requests are generated based on the internet group management protocol (IGMP). In some implementations, the multicast group join requests and multicast group leave requests are generated based on a multicast listener discovery protocol for example in IPV6.

In some implementations, the operation further includes transmitting the multicast traffic based on the multicast group membership status. In some implementations, transmitting the multicast traffic based on the multicast group membership status includes determining a target multicast group of the multicast traffic and transmitting the multicast traffic to devices of the plurality of devices that are associated with the target multicast group. In some implementations, the operations further include determining a lowest modulation and coding scheme (MCS) for each multicast group, determining a target multicast group of the multicast traffic, and transmitting the multicast traffic to devices of the plurality of devices that are associated with the target multicast group using the lowest modulation and coding scheme (MCS) of the target multicast group. In some implementations, the operations further include determining a lowest modulation and coding scheme (MCS) for each multicast group, determining a target multicast group of the multicast traffic, and transmitting the multicast traffic to the plurality of devices using the lowest modulation and coding scheme (MCS) of the target multicast group. In some implementations, the operation further includes generating a multicast group membership table based on the multicast group membership status. In some implementations, the access point includes at least one virtual access point.

### DESCRIPTION OF DRAWINGS

Example implementations will be described and explained with additional specificity and detail through the use of the accompanying drawings in which:

FIG. 1 illustrates a block diagram of an example system including an access point in accordance with some implementations of this disclosure;

FIG. 2 illustrates an example data exchange flow between an access point and a device in accordance with some implementations of this disclosure;

FIG. 3 illustrates a partial block diagram of an example system including an access point and a device in accordance with some implementations of this disclosure;

FIG. 4 illustrates a partial block diagram of an example system including an access point and a device in accordance with some implementations of this disclosure;

FIG. 5 illustrates a target wake time (TWT) service periods of the linked devices;

FIG. 6 illustrate a system implemented with snooping feature in accordance with some implementations of the present disclosure;

FIG. 7 is a flowchart of an example arrangement of operations for a method of determining a radio link to use for a device when the device includes multiple radio links;

FIG. 8 is a flowchart of an example arrangement of operations for a method of limiting the transmission of multicast traffic such that the multicast traffic is not sent to all device in the radio link;

FIG. 9 is a flowchart of an example arrangement of operations for a method of learning the routes of the multicast traffic; and

FIG. 10 is a schematic view illustrating a machine in the example form of a computing device.

Like reference symbols in the various drawings indicate like elements.

### DETAILED DESCRIPTION

Multicast traffic may include communications, such as transmitted messages, that may be sent from an access point to a group of receiving devices (also referred as stations or clients), simultaneously. In some circumstances, multicast traffic used in Wi-Fi systems (e.g., IEEE 802.11 devices or systems) may reduce power consumption in the transmitting and/or receiving devices and may reduce airtime of the communications between the transmitting and receiving devices.

In some circumstances, an Ethernet Bridge may be configured to receive multicast traffic to be distributed to one or more devices. In some implementations, the Ethernet Bridge is configured to distribute the multicast traffic to one or more virtual access points associated with an access point, which may then distribute the multicast traffic to one or more devices. In some circumstances, the access point may include one or more operational frequencies associated with the radio links over which the multicast traffic may be transmitted. For example, the access point may be configured to transmit multicast traffic over a 2.4 GHz radio link, a 5 GHz radio link, and/or a 6 GHz radio link.

In some implementations, an access point includes or associates with one or more virtual access points for each radio link in the access point. For example, an access point associated with a 2.4 GHz radio may include one or more virtual access points for the 2.4 GHz radio. In some implementations, the virtual access points are used to provide different security protocols and/or different network accessibility for a user.

In some circumstances, the virtual access point may obtain multicast traffic, such as from the Ethernet Bridge. In some circumstances, the multicast traffic may be destined for one or more devices that may be coupled to the access point and/or the virtual access point, such as a device that may be wirelessly coupled via Wi-Fi. In some circumstances, the multicast traffic may be transmitted to all devices (e.g., linked devices) associated with the radio link. For example, a virtual access point associated with the 2.4 GHz radio link may transfer or transmit multicast traffic to all linked devices in communication with the 2.4 GHz radio link but may not transfer to a device in communication with the 5 GHz radio link.

In some implementations, the multicast traffic is transmitted to linked devices with a lowest modulation and coding scheme such that the multicast traffic may be received by all linked devices. For example, in instances in which a first device linked with the access point is able to receive up to 16 quadrature amplitude modulation (QAM) signals and a second device linked with the access point is able to receive up to 64 QAM signals, the access point may be configured to transmit the multicast traffic using 16 QAM which is compatible with the first device and the second device. As a result, the access point does not need to send or transmit multiple multicast traffic in different formats separately to each device (i.e., modulation and coding schemes). In some implementations, each linked device to an access point transmitting multicast traffic may be configured to receive the multicast traffic.

In some implementations, an access point is configured to obtain a status of a linked device prior to transmitting multicast traffic. For example, an access point may obtain a power save mode status associated with a linked device. In response to the power save mode status of the linked device being inactive, the access point may be configured to transmit the multicast traffic. In response to the power save mode status of a linked device being active, the access point may be configured to transmit a delivery traffic indication message (DTIM) beacon before transmitting the multicast traffic. In some implementations, following the delivery traffic indication message (DTIM), the access point releases buffered multicast traffic to all of the linked devices. As a result, the multicast traffic is delivered to the linked devices at the same time.

In some implementations, legacy devices may be configured to receive multicast traffic using only one radio link. For example, a legacy device may be configured to receive multicast traffic over either the 2.4 GHz link, or the 5 GHz link.

In some implementations of the present disclosure, devices configured to receive multicast traffic may be configured to use more than one radio link. For example, a linked device may include a 2.4 GHz radio link, a 5 GHz radio link, and/or a 6 GHz radio link and the linked devices may be configured to receive multicast traffic over two or more radio links, simultaneously.

Various implementations of managing the multicast traffic discussed above have some shortcomings. For example, the transmission of the multicast traffic by the access point discussed above may result in unwanted outcomes such as wasting bandwidth, increasing power consumption, and increasing latency.

Aspects of the present disclosure address these and other shortcomings with prior approaches by providing improved multicast routing. According to the present disclosure, an access point may identify a multicast group identifier associated with a communication. Using the multicast group identifier, the access point may identify any devices that are associated in a group. For the communication and/or for subsequent communications, the access point may send multicast communications to those devices in the group instead of to all devices that may be associated with the access point. In doing so, the access point may determine the lowest MCS for the devices within the group, which may improve latency and/or throughput.

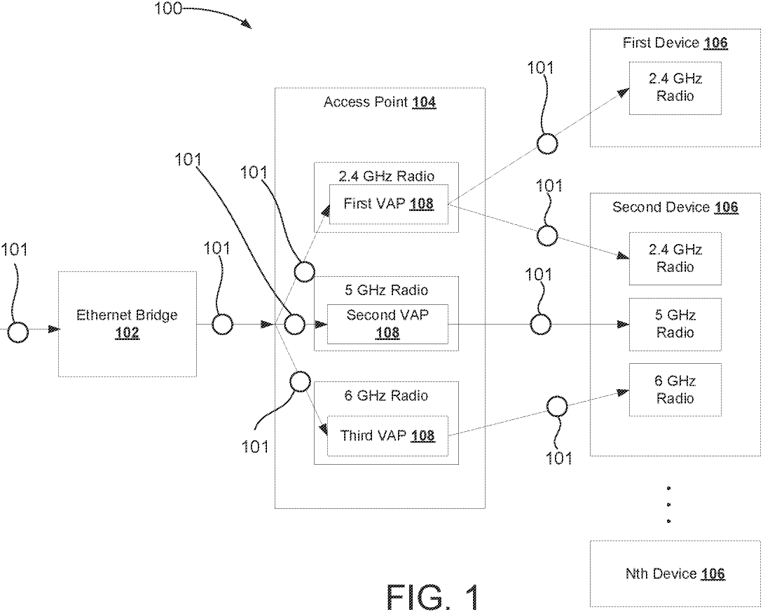

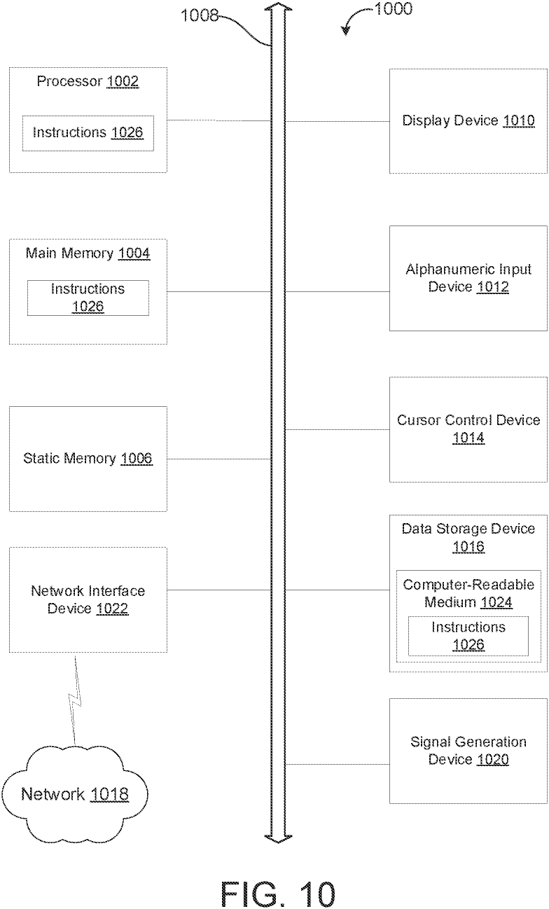

FIG. 1 illustrates a block diagram of an example system 100 including an access point 104 (which is capable of managing multicast traffic) in accordance with some implementations of this disclosure. In some implementations, the access point 104 includes a computing device 1000 shown in FIG. 10.

As shown in FIG. 1, in some implementations, the system 100 includes an Ethernet Bridge 102, the access point 104 (e.g., access point capable of handling multi-link devices) in data communication with the Ethernet Bridge 102, and a plurality of devices 106 (106₁ₛₜ, 106_{2nd} ... 106ₙₜₕ, also referred as stations or clients) in wireless communication (e.g., IEEE 802.11 standards) with the access point 104. As shown, in some implementations, the access point 104 includes one or more virtual access points 108 (108₁ₛₜ, 108_{2nd}, 108_{3rd} ... 108ₙₜₕ). As shown, in some implementations, the Ethernet Bridge 102 is configured to obtain or receive multicast traffic 101 (e.g., streaming of multicast data, multicast packets, or multicast frames). As shown, in some implementations, the Ethernet Bridge 102 is configured to transmit the multicast traffic 101 to the access point 104.

In some implementations, the access point 104 is configured to transmit the multicast traffic 101 to the one or more virtual access points 108. In some implementations, as shown, there is one virtual access point for each radio (e.g., 2.4 GHz, 5 GHz, 6 GHz). For example, as shown, the access point 104 may include a 2.4 GHz radio, a 5 GHz radio, and a 6 GHz radio where each radio includes one virtual access point 108. Alternatively, or additionally, each radio in the access point 104 may include more than one virtual access point 108. For example, the 2.4 GHz radio includes more than one virtual access point 108, the 5 GHz radio includes more than one virtual access point 108, the 6 GHz radio includes more than one virtual access point 108, and so forth.

In some implementations, as shown, one or more devices 106 are configured to communicate with the access point 104 and/or the virtual access point 106 via a radio link (e.g., 2.4 GHz radio link, 5 GHz radio link, 6 GHz radio link). For example, as shown in FIG. 1, the first device 106₁ₛₜ may include a 2.4 GHz radio and may be configured to communicate with a first virtual access point 108₁ₛₜ (2.4 GHz VAP) via a 2.4 GHz radio link. The second device 106_{2nd} may include a 2.4 GHz radio, a 5 GHz radio, and a 6 GHz radio and may be configured to communicate with a first virtual access point 108₁ₛₜ (2.4 GHz VAP), a second virtual access point 108_{2nd} (5 GHz VAP), and a third virtual access point 108_{3rd} (6 GHz VAP) via a 2.4 GHz radio link, a 5 GHz radio link, and a 6 GHz radio link, respectively. In some implementations, as shown, the linked devices 106 include one or more radios (e.g., 2.4 GHz, 5 GHz, 6 GHz) such that the linked devices 106 may be configured to communicate with one or more virtual access points 108. In some implementations, a linked device 106 is configured to receive multicast traffic 101 from more than one radio link. For example, as shown in FIG. 1, the second device 106_{2nd} may be configured to receive the multicast traffic 101 via the 2.4 GHz radio link, the 5 GHz radio link, and the 6 GHz radio link. Other combinations of radio links transmitting multicast traffic 101 may be possible. For example, a linked device 106 may be configured to receive multicast traffic 101 via the 2.4 GHz radio link and the 6 GHz radio link, or via the 2.4 GHz radio link and the 5 GHz radio link. The combinations of radio links and linked devices is illustrative only and not limiting.

In some implementations, as shown, the access point 104 is configured to replicate the multicast traffic 101 to all virtual access points 108. In some implementations, the virtual access points 108 are configured to transmit the multicast traffic 101 to all linked devices 106. For example, the first virtual access point 108₁ₛₜ (2.4 GHz VAP) may be configured to transmit multicast traffic 101 to the first device 106₁ₛₜ and the second device 106_{2nd}, as both the first device 106₁ₛₜ and the second device 106_{2nd} include a 2.4 GHz radio link. Similarly, the second virtual access point 108_{2nd} (5 GHz VAP) may be configured to transmit multicast traffic 101 to the second device 106_{2nd} as the second device 106_{2nd} includes a 5 GHz radio link. Likewise, the third virtual access point 108_{3rd} (6 GHz VAP) may be configured to transmit multicast traffic 101 to the second device 106_{2nd} as the second device 106_{2nd} includes a 6 GHz radio link.

In some implementations, the multicast traffic 101 is transmitted to linked devices 106 with a lowest modulation and coding scheme such that the multicast traffic 101 is received by all linked devices 106. For example, as shown, in instances in which the first device 106₁ₛₜ is capable of receiving up to 16 quadrature amplitude modulation (QAM) multicast traffic 101 (due to hardware, software and/or link quality) and a second device 106_{2nd} is capable of receiving up to 64 QAM multicast traffic 101 (due to hardware, software and/or link quality), the first virtual access point 108₁ₛₜ (2.4 GHz VAP) is configured to transmit the multicast traffic 101 using the 16 QAM which is compatible with the first device 106₁ₛₜ and the second device 106_{2nd}. In other words, in some implementations, the virtual access point 108 is configured to transmit the multicast traffic 101 in a format (e.g., modulation, coding) which is compatible with all the devices 106 linked to the virtual access point 108 in accordance with some implementations of this disclosure.

In some implementations, each linked device 106 to an access point 104 transmitting multicast traffic 101 is configured to receive the multicast traffic 101.

In some implementations, any devices 106 communicatively coupled to a transmitting virtual access point 108 receive all the multicast traffic 101 that is transmitted. For example, as shown, in instances where the first virtual access point 108₁ₛₜ (2.4 GHz VAP) transmits the multicast traffic 101, and both the first device 106₁ₛₜ and the second device 106_{2nd} receive the multicast traffic 101.

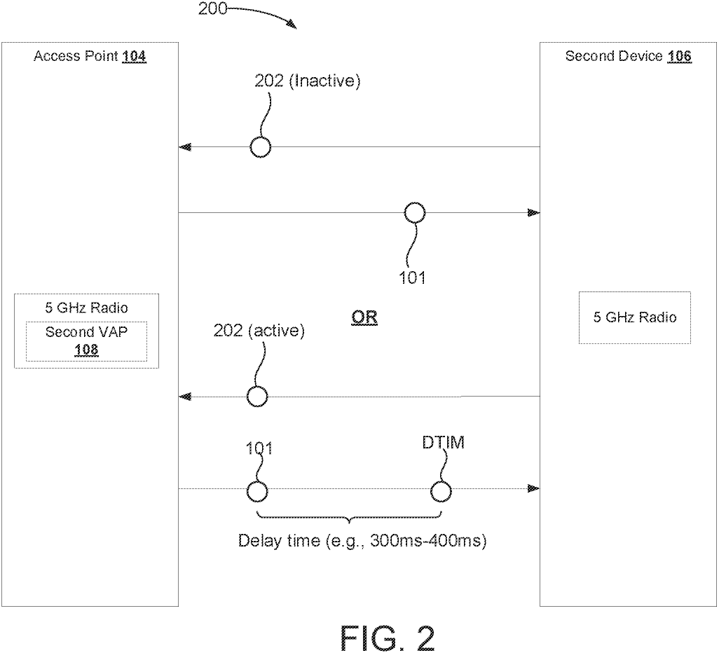

FIG. 2 illustrates an example data exchange flow 200 between an access point 104 and a device 106 in accordance with some implementations of this disclosure.

As shown in FIG. 2, in some implementations, an access point 104 (or virtual access point 108 associated with the access point 104) is configured to obtain a status 202 of a linked device 106 prior to transmitting the multicast traffic 101. For example, as shown, the second virtual access point 108_{2nd} (5 GHz VAP) obtains a power save mode status 202 associated with the second device 106_{2nd}. In response to the power save mode status 202 of the second device 106_{2nd} being inactive, the second virtual access point 108_{2nd} (5 GHz VAP) is configured to transmit the multicast traffic 101. In response to the power save mode status 202 of the second device 106_{2nd} being active, the second virtual access point 108_{2nd} is configured to transmit a delivery traffic indication message (DTIM) beacon before transmitting the multicast traffic 101 to the second device 106_{2nd} and other devices 106 linked to the second virtual access point 108_{2nd}. As a result, this causes increasing of latency not only between the second device 106_{2nd} and the second virtual access point 108_{2nd} (5 GHz VAP) but also between other devices 106 linked to the second virtual access point 108_{2nd} that are not in power save mode.

Various implementations of transmitting the multicast traffic 101 discussed above have some shortcomings. For example, the replication of the multicast traffic 101 by the access point 104 may result in wasted bandwidth of the system 100. For example, the access point 104 replicates the multicast traffic 101 to a radio that includes a poor link quality. A poor link quality may include noise in the channel that may reduce the quality of the multicast traffic 101 and/or make the multicast traffic 101 unusable by a linked device 106. Alternatively, or additionally, the bandwidth of the system 100 may be wasted as the multicast traffic 101 is transmitted using a lowest modulation and coding scheme that may be received by all linked devices 106, including to a device 106 that may discard the multicast traffic 101 (e.g., device 106 not subscribed to a multicast group associated with multicast traffic 101). For example, multicast traffic 101 may be transmitted to the first device 106₁ₛₜ and the second device 106_{2nd} using a lower modulation and coding scheme (e.g., to accommodate the first device 106₁ₛₜ) in instances in which the first device 106₁ₛₜ discards the transmitted multicast traffic 101. As result, the multicast traffic 101 is transmitted to the second device 106_{2nd} in a less efficient way (e.g., slower transmission rate) which requires more air time.

The shortcomings also include a possibility of wasting power of some linked devices 106. For example, multicast traffic 101 may be transmitted to a linked device 106 over multiple radio links (e.g., 2.4 GHz, 5 GHz, 6 GHz) even in instances when either one of the radio links may be configured to deliver the multicast traffic 101. In some occasions, the linked devices 106 that may not be an intended recipient of multicast traffic 101 may still be powered on (e.g., and not in a power save mode) which may waste device power. For example, multicast traffic 101 over the 2.4 GHz radio link and intended for the second device 106_{2nd} may cause the first device 106₁ₛₜ to remain on and not in a power save mode, as it may be coupled to the 2.4 GHz radio link along with the second device 106_{2nd}.

The shortcomings also include a possibility of increasing latency in receiving multicast traffic 101. For example, one or more devices 106 coupled to a radio link may experience increasing latency in receiving multicast traffic 101 due to another device 106 coupled to the radio link. For example, as discussed above, in instances in which the second device 106₁ₛₜ is coupled to the 2.4 GHz radio link and is in a power save mode, any multicast traffic 101 scheduled to be transmitted over the 2.4 GHz radio link may be delayed until the first device 106₁ₛₜ is not in power save mode, such as receiving by receiving a DTIM beacon. To address the shortcomings, this disclosure further includes several implementations as described below.

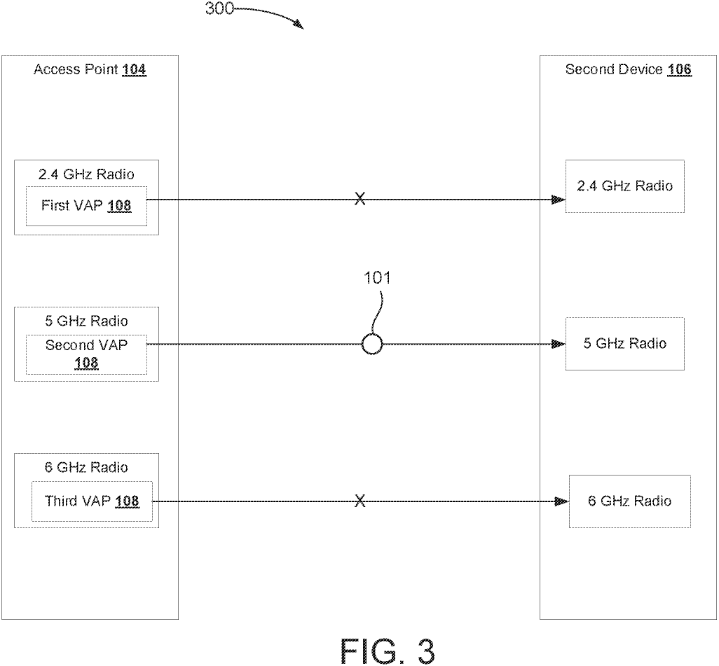

FIG. 3 illustrates a partial block diagram of an example system 300 including an access point 104 (which is capable of managing multicast traffic/multicast communication) and a device 106 in accordance with some implementations of this disclosure.

In some implementations, as shown, the access point 104 is configured to manage the delivery of multicast traffic 101 to the linked devices 106, such as by determining radio links to be used by devices 106. For example, as shown, the access point 104 may direct a linked device 106 including multiple radio links (e.g., such as the second device 106_{2nd} which as illustrated, includes a 2.4 GHz radio link, a 5 GHz radio link, and a 6 GHz radio link) to use one of the radio links that may have better performance or channel conditions (e.g., greater data transmission rate) than the other radio links. For example, in instances in which the 2.5 GHz radio link, the 5 GHz radio link, and the 6 GHz radio link each includes a good communication channel and the 5 GHz radio link includes a greater data transmission rate, the access point 104 may determine the 5 GHz radio link be used to transmit multicast traffic 101. In some implementations, the access point 104 direct the device 106 (second device 106_{2nd} in this example) to use the radio link (5 GHz in this example) that performs better than the other radio links. In some implementations, the access point 104 stops transmitting the multicast traffic 101 to the device 106 via the less efficient radio links (2.4 GHz and 6 GHz in this example). In some implementations, the access point 104 is configured to disable radios (2.4 GHz and 6 GHz in this example) in the device 106 (second device 106_{2nd} in this example) that are not efficient (e.g., slower data transmission rate). In some implementations, the access point 104 may instruct the device 106 (second device 106_{2nd} in this example) to active power save mode for the less efficient radios (2.4 GHz and 6 GHz in this example) in the device 106.

In some implementations, the access point 104 is configured to enable (e.g., de-active power save mode) all of the radios in the second device 106_{2nd} to re-evaluate the data transmission rate for each radios in the second device 106_{2nd}. In some implementations, based on the result from the re-evaluation, the access point 104 is configured to disable radios that are not efficient. For example, the access point 104 may determine an efficiency metric for each radio. If any efficiency metrics for any of the radios are below a threshold efficiency value, the access point 104 may reduce the power in any radio with the efficiency matric below the threshold efficiency value. Reduction in power may include a reduction in any amount of power, including a slight reduction, a full reduction (power off), reduction to a sleep mode, or hibernation, etc. In some implementations, the re-evaluation occurs periodically or randomly. Alternatively, or additionally, in some implementations, the access point 104 is implemented with enhanced multi-link single radio (eMLSR) protocols which may optimize the radio link usage.

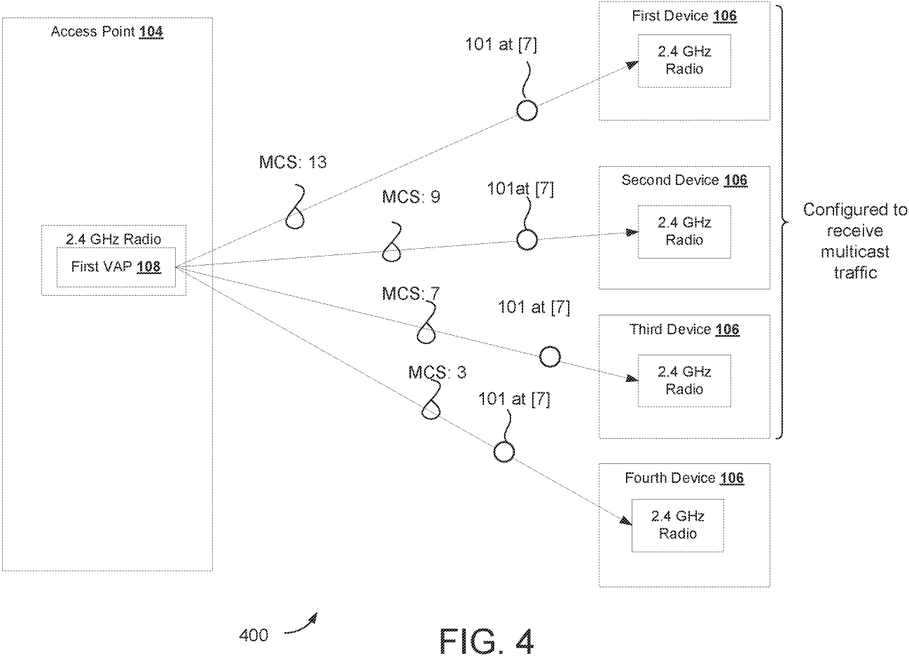

FIG. 4 illustrates a partial block diagram of an example system 400 including an access point 104 (which is capable of managing multicast traffic/multicast communication) and a device 106 in accordance with some implementations of this disclosure.

In some implementations, the access point 104 is configured to limit the transmission of some multicast traffic 101 such that the multicast traffic 101 is not sent to all devices 106 in the radio link. For example, as shown, the access point 104 is configured to determine that whether each of the linked devices 106 (devices 106 linked to the first virtual access point 108₁ₛₜ in this example) are configured to receive the multicast traffic 101. In some implementations, as shown, the access point 104 is configured to determine the lowest modulation and coding scheme among the determined linked devices 106 (i.e., linked devices 106 configured to receive the multicast traffic 101). In some implementations, the access point 104 is configured to transmit the multicast traffic 101 using the lowest modulation and coding scheme to the determined linked devices 106 only. As a result, the virtual access point 108 (first virtual access point 108₁ₛₜ in this example) of the access point 104 transmits the multicast traffic 101 to all of the device 106 configured to receive the multicast traffic 101 (first device 106₁ₛₜ, second device 106_{2nd}, and third device 106_{3rd} that are linked to the first virtual access point 108₁ₛₜ (2.4 GHz VAP) and configured to receive the multicast traffic 101 in this example). In this example, the virtual access point (first virtual access point 108₁ₛₜ in this example) does not transmit the multicast traffic 101 to the fourth device 106₄ₜₕ which is not configured to receive the multicast traffic 101. According, the fourth device 106₄ₜₕ can be in the power save mode without interrupted by the multicast traffic 101 (e.g., receiving the DTIM beacon). This also reduce a chance of increasing the latency created by transmitting the DTIM beacon to a device 106 in power save mode (fourth device 106₄ₜₕ in this example). Alternatively, or additionally, in some implementations, the access point 104 is configured to cause the linked devices 106 not receiving the multicast traffic 101 to commence power save mode. As discussed, in some implementations, the access point 104 is configured to allow linked device 106 (fourth device 106₄ₜₕ in this example) to commence power save mode by not sending the multicast traffic 101.

In some implementations, as shown, the virtual access point (first virtual access point 108₁ₛₜ in this example) does transmit the multicast traffic 101 to all of the devices 106 including the device 106 (fourth device 106₄ₜₕ in this example) which is not configured to receive the multicast traffic 101. This method is still beneficial since the virtual access point 108 transmits the multicast traffic 101 at the best rate for the devices 106 that are configured to receive the multicast traffic 101.

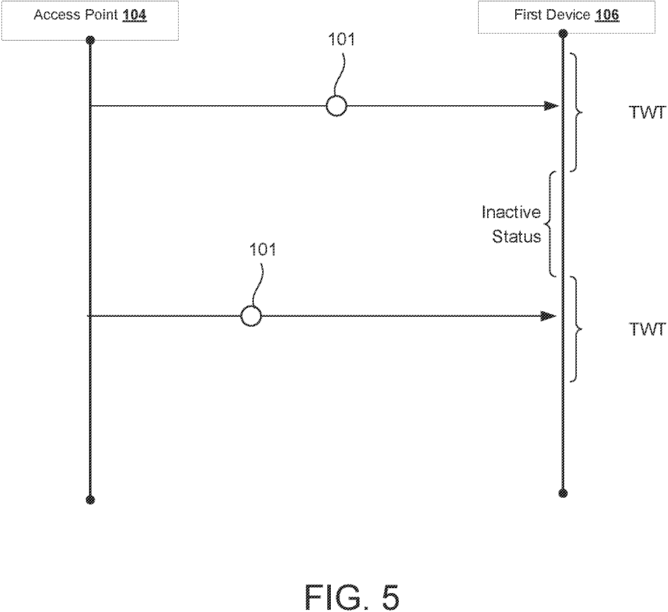

As shown in FIG. 5, in some implementations, the access point 104 is configured to schedule the transmission of multicast traffic 101 during a target wake time (TWT) service period of the linked devices 106. In some implementations, each linked device 106 includes a TWT during which the linked device 106 is configured to available to receive multicast traffic transmissions. For example, as shown, the access point 104 may schedule a transmission of multicast traffic 101 to the first device 106₁ₛₜ during a TWT of the first device 106₁ₛₜ. In instances in which the first device 106₁ₛₜ is outside the TWT, the first device 106₁ₛₜ may enter a power save mode, which may conserve some power of the first device 106₁ₛₜ. Alternatively, or additionally, in some implementations, the access point 106 is configured to transmit multicast traffic 101 to a linked device 106 following the transmission of low latency traffic during the TWT of the linked device 106.

In some implementations, the linked devices 106 may be configured to follow the instructions provided by the access point 104. For example, the linked devices 106 may be configured to implement the management and/or scheduling provided by the access point 104. In some implementations, the linked devices 106 is configured to implement the access point instructions in lieu of performance. For example, some of the linked devices 106 may experience increased latency and/or increased power consumption to implement the instructions provided by the access point 104.

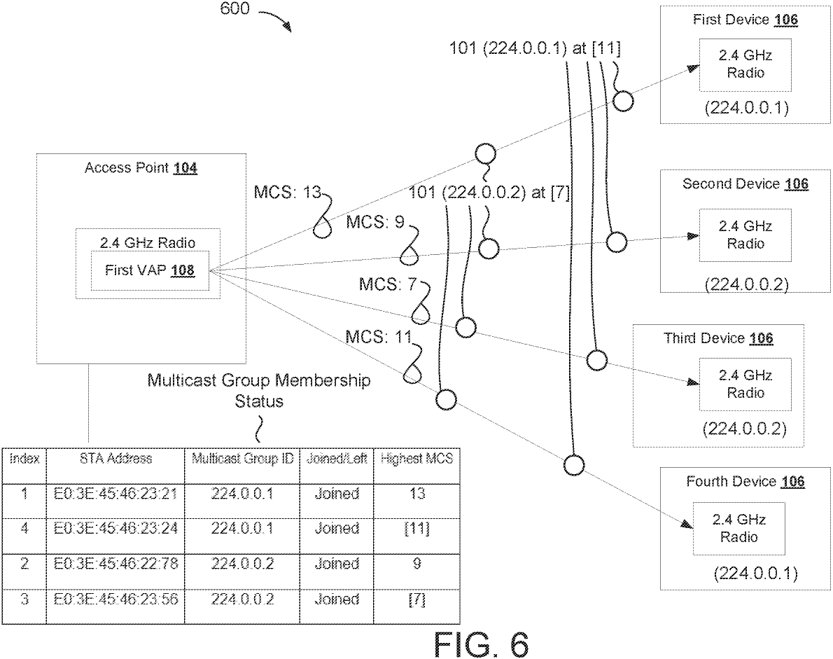

As shown in FIG. 6, in some implementations, the delivery of multicast traffic 101 can be improved by learning routes of the multicast traffic 101 and only targeting the devices 106 in the multicast group (e.g., multicast identification), thereby improving airtime. Example multicast traffic 101 that can benefit from the techniques described in the present disclosure includes video conferencing applications, Internet protocol televisions (IPTV), Internet protocol cameras (IP Cameras), game streaming, network , and application control traffic such as ARP, file distribution (stock market quotes, new software distribution,), etc.

As part of learning the routes of the multicast traffic 101, multicast subscription related data (e.g., multicast group join request, multicast group leave request) from the linked devices 206 can be snooped at the access point 104. In some embodiments, rather than (or in addition to) snooping, the access point 104 may identify the multicast group from any source. For example, the access point 104 may receive a group ID for the multicast group. The Ethernet Bridge, for example, may send a communication with a group ID for the multicast group. Any device also may include, with any communications, a group ID for the multicast group. The group ID for the multicast group may also include a list of members of the multicast group. The access point 104 may also use the group ID for the multicast group with a lookup table to identify the members of the multicast group. The access point 104 may also send a query to another device, based on the group ID for the multicast group, to identify the members of the multicast group.

In some implementations, the multicast subscription related data is based on internet group management protocol (IPv4). In some implementations, the multicast subscription related data is based on multicast listener discovery protocol (IPv6). In some implementations, the multicast group join request includes an identification (IP address between 224.0.0.0 and 239.255.255.255) of multicast group that the device 106 (associated with the join request) requests to join to. In some implementations, the leave multicast group request includes an identification (IP address) of multicast group that the device 106 (associated with the leave request) requests to leave from.

As shown, in some implementations, based on a result from snooping the multicast subscription related data from the linked devices 106 (first device 106₁ₛₜ, second device 106_{2nd}, third device 106_{3rd}, fourth device 106₄ₜₕ in this example), the access point 104 determines a multicast group membership status of each of the linked devices 106. In this example, the access point 104 determines that the first device 106₁ₛₜ and the fourth device 106₄ₜₕ linked to the first virtual access point 108₁ₛₜ (2.4 GHz VAP) are in a first multicast group (224.0.0.1) and the second device 106_{2nd} and the third device 106_{3rd} are in a second multicast group (224.0.0.2). As shown, in some implementations, the access point 104 determines modulation and coding scheme (MCS) index for each link. As shown, in this example, the MCS index of a 2.4 GHz link between the first virtual access point 108₁ₛₜ (2.4 GHz VAP) and the first device 106₁ₛₜ, between the first virtual access point 108₁ₛₜ (2.4 GHz VAP) and the second device 106_{2nd}, between the first virtual access point 108₁ₛₜ (2.4 GHz VAP) and the third device 106_{3rd}, and between the first virtual access point 108₁ₛₜ (2.4 GHz VAP) and the fourth device 106₄ₜₕ are 13, 9, 7, and 11, respectively.

In some implementations, when the virtual access point 108 of the access point 104 (first virtual access 108₁ₛₜ in this example) receives multicast traffic 101 associated with the first multicast group (224.0.0.1 in this example), the virtual access point 108 (first virtual access 108₁ₛₜ in this example) is configured to transmit the multicast traffic 101 associated with the first multicast group to the linked devices 106 (first device 106₁ₛₜ and forth device 106₄ₜₕ in this example) that are the members of the first multicast group only. To improve the transmission rate, reduce use of air time, and/or better use of bandwidth, in some implementations, the virtual access point 108 (first virtual access 108₁ₛₜ in this example) of the access point 104 is configured to transmit the multicast traffic 101 associated with the first multicast group at the best rate which is the lowest MSC (11 in this example) associated with the first multicast group. It is also beneficial that this method does not require or cause all the linked device 106 (first device 106₁ₛₜ, second device 106_{2nd}, third device 106_{3rd}, forth device 106₄ₜₕ in this example) to remain on and not in a power save mode. Therefore, there is a less chance of transmitting the DTIM beacon. When the virtual access point 108 transmits the multicast traffic 101 associated with the first multicast group (224.0.0.1 in this example), as long as all the linked devices 106 (first device 106₁ₛₜ and forth device 106₄ₜₕ in this example) associated with the first multicast group are remain on and not in a power save mode, the virtual access point 108 does not have to transmit the DTIM beacon which increases latency. In other words, other linked devices 106 (second device 106_{2nd} and third device 106_{3rd} in this example) not associated with the first multicast group can be remain off and in a power save mode while the virtual access point 108 is transmitting the multicast traffic 101 associated with the first multicast group.

In some implementations, as shown, the virtual access point 108 (first virtual access 108₁ₛₜ in this example) is configured to transmit the multicast traffic 101 associated with the first multicast group to all linked devices 106 (first device 106₁ₛₜ, second device 106_{2nd}, third device 106_{3rd}, forth device 106₄ₜₕ in this example) using the lowest MCS associated with the first multicast group. As a result, non-member devices (second device 106_{2nd} and third device 106_{3rd} in this example) may receive multicast traffic 101 that is corrupted. However, this method is still beneficial since the virtual access point 108 (first virtual access point 108₁ₛₜ) is able to transmit the multicast traffic 101 associated with the first multicast group to the member devices (first device 106₁ₛₜ and forth device 106₄ₜₕ in this example) of the first multicast group using the best rate (MCS 11 in this example).

Similarly, in some implementations, when the virtual access point 108 of the access point 104 (first virtual access 108₁ₛₜ in this example) receives multicast traffic 101 associated with the second multicast group (224.0.0.2 in this example), the virtual access point 108 (first virtual access 108₁ₛₜ in this example) is configured to transmit the multicast traffic 101 associated with the second multicast group to the linked devices 106 (second device 106_{2nd} and third device 106_{3rd} in this example) that are the members of the second multicast group only. To improve the transmission rate, reduce use of air time, and/or better use of bandwidth, in some implementations, the virtual access point 108 (first virtual access 108₁ₛₜ in this example) of the access point 104 is configured to transmit the multicast traffic 101 associated with the second multicast group at the best rate which is the lowest MSC (7 in this example) associated with the second multicast group. It is also beneficial that this method does not require or cause all the linked device 106 (first device 106₁ₛₜ, second device 106_{2nd}, third device 106_{3rd}, forth device 106₄ₜₕ in this example) to remain on and not in a power save mode. Therefore, there is a less chance of transmitting the DTIM beacon. When the virtual access point 108 transmits the multicast traffic 101 associated with the second multicast group (224.0.0.2 in this example), as long as all the linked devices 106 (second device 106_{2nd} and third device 106_{3rd} in this example) associated with the second multicast group are remain on and not in a power save mode, the virtual access point 108 does not have to transmit the DTIM beacon which increases latency. In other words, other linked devices 106 (first device 106₁ₛₜ and fourth device 106₄ₜₕ in this example) not associated with the second multicast group can be remain off and in a power save mode while the virtual access point 108 is transmitting the multicast traffic 101 associated with the second multicast group.

In some implementations, as shown, the virtual access point 108 (first virtual access 108₁ₛₜ in this example) is configured to transmit the multicast traffic 101 associated with the second multicast group to all linked devices 106 (first device 106₁ₛₜ, second device 106_{2nd}, third device 106_{3rd}, forth device 106₄ₜₕ in this example) using the lowest MCS associated with the second multicast group. As a result, non-member devices (the first device 106₁ₛₜ and fourth device 106₄ₜₕ in this example) may receive multicast traffic 101. However, this method is still beneficial since the virtual access point 108 (first virtual access point 108₁ₛₜ) is able to transmit the multicast traffic 101 associated with the second multicast group to the member devices (second device 106_{2nd} and third device 106_{3rd} in this example) of the second multicast group using the best rate (MCS 7 in this example).

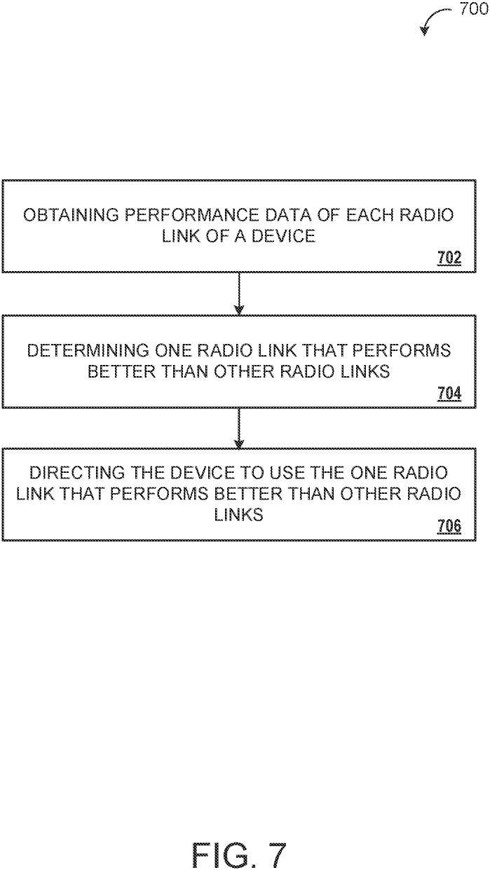

FIG. 7 is a flowchart of an example arrangement of operations for a method 700 of determining a radio link to use for a device 106 when the device 106 includes multiple radio links (e.g., 2.4 GHz, 5 GHz, 6 GHz). The method 700 may be performed by processing logic that may include hardware (circuitry, dedicated logic, etc.), software (such as is run on a general purpose computer system or a dedicated machine), or a combination of both, which processing logic may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

As discussed above, in some implementations, the access point 104 is configured to direct a linked device 106 including multiple radio links to use one of the radio links that performs better than the other radio links (e.g., greater data transmission rate).

The method 700, at operation 702, includes obtaining or receiving the performance data of each radio link (e.g., data transmission rate, signal-to-noise ratio, MCS).

The method 700, at operation 704, includes determining one radio link that performs better than the other radio links based on the data. In some implementations, the access point 104 is configured to determine the one radio link that performs better than other radio links based on the data transmission rates of each radio link. In some implementations, the access point 104 is configured to determine the one radio link that performs better than other radio links based on the signal-to-noise ratio. In some implementations, access point 104 is configured to determine the one radio link performs better than other radio links based on the MCS data.

The method 700, at operation 706, includes directing the device 106 to use the one radio link that performs better than other radio link (e.g., greater data transmission rate, lower signal-to-noise ratio, greater MCS).

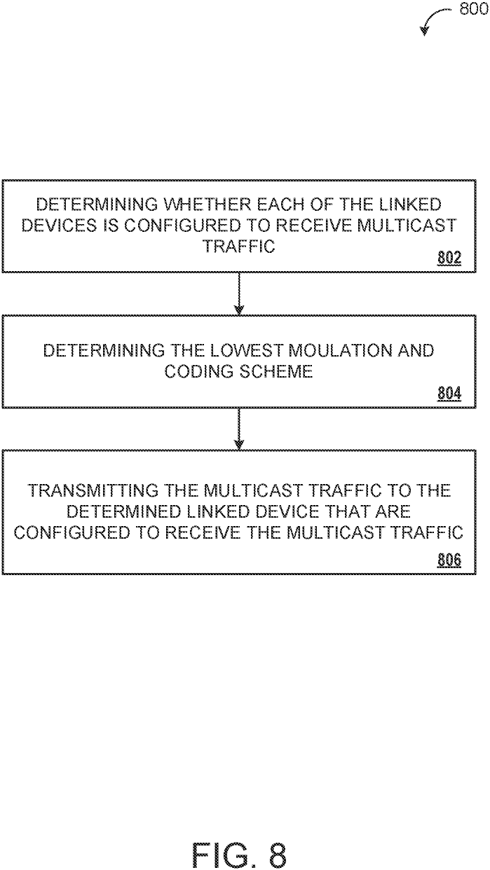

FIG. 8 is a flowchart of an example arrangement of operations for a method 800 of limiting the transmission of multicast traffic 101 such that the multicast traffic 101 is not sent to all device 106 in the radio link. The method 800 may be performed by processing logic that may include hardware (circuitry, dedicated logic, etc.), software (such as is run on a general purpose computer system or a dedicated machine), or a combination of both, which processing logic may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 800, at operation 802, includes determining whether each of the linked devices 106 (e.g., devices 106 linked to a virtual access point 108) is configured to receive the multicast traffic 101.

The method 800, at operation 804, includes determining the lowest modulation and coding scheme associated with the determined linked devices 106 (devices 106 configured to receive the multicast traffic 101).

The method 800, at operation 806, includes transmitting the multicast traffic 101 to the determined linked devices 106 configured to receive the multicast traffic 101 using the lowest modulation and coding scheme.

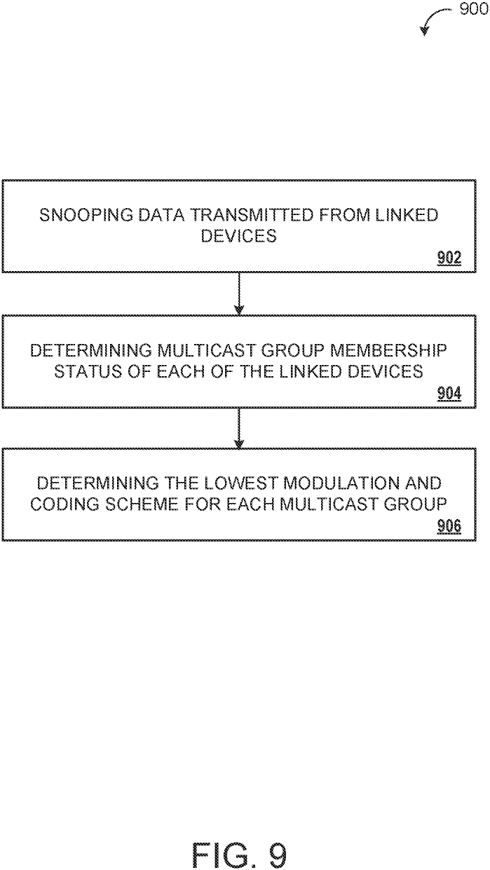

FIG. 9 is a flowchart of an example arrangement of operations for a method 900 of learning the routes of the multicast traffic 101. The method 900 may be performed by processing logic that may include hardware (circuitry, dedicated logic, etc.), software (such as is run on a general purpose computer system or a dedicated machine), or a combination of both, which processing logic may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 900, at operation 902, includes snooping data transmitted from linked devices 106. Snooping data may including identifying a multicast group from any source, identifying a multicast group ID, one or more devices associated with a multicast group, etc.

The method 900, at operation 904, includes determining multicast subscription status of the linked devices 106 based on the data (e.g., multicast group join request, multicast group leave request in the data). In some implementations, the multicast group membership status includes identification of all the multicast groups associated with the device 106.

The method 900, at operation 906, includes determining the lowest modulation and coding scheme for each multicast group. In some implementations, the multicast group membership status includes the modulation and coding scheme associated each devices 106. In some implementations, the multicast group membership status includes the modulation and coding scheme associated with each multicast group.

FIG. 10 is a schematic view illustrating a machine in the example form of a computing device 1000 within which a set of instructions, for causing the machine to perform any one or more of the methods discussed herein, may be executed. The computing device 1000 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 1000 includes a processing device (e.g., a processor) 1002, a main memory 1004 (e.g., read-only memory (ROM), flash memory, dynamic random access memory (DRAM) such as synchronous DRAM (SDRAM)), a static memory 1006 (e.g., flash memory, static random access memory (SRAM)) and a data storage device 1016, which communicate with each other via a bus 1008.

Processing device 1002 represents one or more general-purpose processing devices such as a microprocessor, central processing unit, or the like. More particularly, the processing device 1002 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also include one or more special-purpose processing devices such as an application specific integrated circuit (ASIC), a field programmable gate array (FPGA), a digital signal processor (DSP), network processor, or the like. The processing device 1002 is configured to execute instructions 1026 for performing the operations and steps discussed herein.

The computing device 1000 may further include a network interface device 1022 which may communicate with a network 1018. The computing device 1000 also may include a display device 1010 (e.g., a liquid crystal display (LCD) or a cathode ray tube (CRT)), an alphanumeric input device 1012 (e.g., a keyboard), a cursor control device 1014 (e.g., a mouse) and a signal generation device 1020 (e.g., a speaker). In at least one implementation, the display device 1010, the alphanumeric input device 1012, and the cursor control device 1014 may be combined into a single component or device (e.g., an LCD touch screen).

The data storage device 1016 may include a computer-readable storage medium 1024 on which is stored one or more sets of instructions 1026 embodying any one or more of the methods or functions described herein. The instructions 1026 may also reside, completely or at least partially, within the main memory 1004 and/or within the processing device 1002 during execution thereof by the computing device 1000, the main memory 1004 and the processing device 1002 also constituting computer-readable media. The instructions may further be transmitted or received over a network 1018 via the network interface device 1022.

While the computer-readable storage medium 1026 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method for communicating multicast traffic, the method comprising:
snooping, at an access point, data received from a plurality of devices, the plurality of devices in wireless communication with the access point; and
determining, by the access point, a multicast group membership status of each of the devices based on a result from snooping.

2. The method of claim 1, wherein snooping the data from the plurality of devices includes identifying multicast group join requests and multicast group leave requests from the data.

3. The method of claim 2, wherein the multicast group join requests and multicast group leave requests are generated based on an internet group management protocol (IGMP).

4. The method of claim 2, wherein the multicast group join requests and multicast group leave requests are generated based on a multicast listener discovery protocol.

5. The method of claim 1, further comprising: transmitting, by the access point, the multicast traffic based on the multicast group membership status.

6. The method of claim 5, wherein transmitting the multicast traffic based on the multicast group membership status includes: determining a target multicast group of the multicast traffic and transmitting the multicast traffic to devices of the plurality of devices that are associated with the target multicast group.

7. The method of claim 1, further comprising:
determining a lowest modulation and coding scheme (MCS) for each multicast group;
determining a target multicast group of the multicast traffic; and
transmitting the multicast traffic to devices of the plurality of devices that are associated with the target multicast group using the lowest modulation and coding scheme (MCS) associated with the target multicast group.

8. The method of claim 1, further comprising:
determining a lowest modulation and coding scheme (MCS) for each multicast group;
determining a target multicast group of the multicast traffic; and
transmitting the multicast traffic to the plurality of devices using the lowest modulation and coding scheme (MCS) associated with the target multicast group.

9. The method of claim 1, further comprising: generating a multicast group membership table based on the multicast group membership status.

10. The method of claim 9, wherein the access point includes at least one virtual access point.

11. An access point for communication of multicast traffic, the access point comprising:
data processing hardware; and
memory hardware in communication with the data processing hardware, the memory hardware storing instructions that when executed on the data processing hardware cause the data processing hardware to perform operations comprising:
snoop data received from a plurality of devices, the plurality of devices in wireless communication with the access point; and
determine a multicast group membership status of each of the devices.

12. The access point of claim 11, wherein snooping the data from the plurality of devices includes identify multicast group join requests and multicast group leave requests from the data.

13. The access point of claim 12, wherein the multicast group join requests and multicast group leave requests are generated based on an internet group management protocol (IGMP).

14. The access point of claim 12, wherein the multicast group join requests and multicast group leave requests are generated based on a multicast listener discovery protocol.

15. The access point of claim 11, the operations further comprising:
transmit the multicast traffic based on the multicast group membership status.

16. The access point of claim 15, wherein a legacy device is included in the multicast group, wherein the multicast traffic is transmitted to the legacy device using one radio link.

17. The access point of claim 15, wherein transmit the multicast traffic based on the multicast group membership status includes: determine a target multicast group of the multicast traffic and transmit the multicast traffic to devices of the plurality of device that are associated with the target multicast group.

18. The access point of claim 11, the operations further comprising:
determine a lowest modulation and coding scheme (MCS) for each multicast group;
determine a target multicast group of the multicast traffic; and
transmit the multicast traffic to devices of the plurality of devices that are associated with the target multicast group using the lowest modulation and coding scheme (MCS) associated with the target multicast group.

19. The access point of claim 11, the operations further comprising:
determine a lowest modulation and coding scheme (MCS) for each multicast group;
determine a target multicast group of the multicast traffic; and
transmit the multicast traffic to the plurality of devices using the lowest modulation and coding scheme (MCS) associated with the target multicast group.

20. The access point of claim 11, the plurality of devices including a particular device having a plurality of radios, the operations further comprising:
evaluate a data transmission rate for each radio of the plurality of radios of the particular device; and
responsive to a determination that a particular radio in the plurality of radios has an efficiency metric that is below a threshold efficiency value, reducing the power of the particular radio.
